(19) United States
(12) Patent Application Publication
(10) Pub. No.: US 2012/0241011 A1
(43) Pub. Date: Sep. 27, 2012

(54) Valve having a magnet stack

(76) Inventors: Rainer Walter, Pleidelsheim (DE); Ralph Engelberg, Ditzingen (DE)

(21) Appl. No.: 13/499,090

(22) PCT Filed: Jul. 29, 2010
(86) PCT No.: PCT/EP2010/061041

§ 371 Date: Jun. 11, 2012

(30) Foreign Application Priority Data
Sep. 30, 2009 (DE) 10 2009 045 174.9

(51) Int. Cl. F16K 31/06

(52) U.S. Cl. 137/1; 251/129.15; 251/337

(57) ABSTRACT

In a valve for controlling a fluid passage, a valve needle is actuated by a first electromagnetic drive having a first armature element and is reset by a return element, and a second electromagnetic drive is provided having a second armature element for actuating the valve needle. The first and second electromagnetic drive are configured in series.

### BACKGROUND OF THE INVENTION

1. Field of the Invention

The present invention relates to a valve for controlling a fluid passage with improved dynamics, and to a method for controlling a fluid passage using a valve needle or a sliding element, such that in the currentless state the fluid passage can be open or closed.

2. Description of Related Art

Valves having magnetic circuits as an electromagnetic drive are known in various embodiments, and are distinguished for example with regard to their switching times, their valve strokes, the functioning of their magnetic circuits as in valves having a proportional or two-point switching magnet, or with respect to the design of their magnetic circuits, as in magnetic circuits having a solenoid plunger or a flat armature.

As a rule, the magnetic circuit works against a return spring. In this case, the overall dynamic characteristic of the valve is determined by the magnet of the magnetic circuit, the division into attraction time and release time being determined by the spring. Decisive factors for the attraction time and release time of the magnet are the speed of the buildup of the magnetic field in the magnetic circuit, the force of the return spring that is to be overcome (the greater the force of the return spring, the slower the attraction time, and the faster the release time of the magnet), the valve stroke, and further mechanical quantities in the valve, such as the overall mass that is to be moved and other forces. In addition, the force level that is achieved is also important for the attraction time of the magnet.

The dynamic behavior of the valve having an electromagnetic drive is limited by technical factors. For example, a large valve stroke always has comparatively longer switching times as a consequence, because the valve needle requires more time to be attracted and to be released, and the achievable magnetic force in the case of large strokes is correspondingly small due to the magnetic residual air gap. Indirectly, however, the large valve stroke also has an influence on the speed of the magnetic field buildup and on the magnetic force. This is true to a particular degree for flat armature magnets, which can produce relatively large forces and are therefore particularly suitable with regard to dynamics.

It has already been proposed to replace the electromagnetic drive in a valve by a piezoelectric drive in order to further improve the dynamics, but this solution is economically feasible only to a limited extent due to the significantly higher cost of a piezoelectric drive.

### BRIEF SUMMARY OF THE INVENTION

In contrast, the valve according to the present invention for controlling a fluid passage has the advantage that, despite the use of economical electromagnetic drives in the valve, the dynamic behavior of the valve is significantly improved. In particular, the valve according to the present invention can still execute fast switching even with large strokes. This is achieved according to the present invention in that the valve has a valve needle or a valve slide that is actuated by armature elements of at least two different electromagnetic drives. The two electromagnetic drives, and thus the two armature elements, are configured in series, and can be reset together by a return element. The basic idea of the series configuration is to reinforce the actuating force for the valve needle applied by an electromagnetic drive by using at least one additional electromagnetic drive situated in series. The division of a large drive into at least two small magnetic drives makes it possible to achieve a greater dynamic characteristic in the buildup of magnetic force. The simple series configuration of the electromagnetic drives makes it possible in this way to economically produce a sufficiently large actuating force even for very large strokes of the valve needle, said force moving the valve needle with a high dynamic characteristic and adjusting the valve in order to control the fluid passage. The speed of the valve needle can be set via the number of electromagnetic drives connected in series, so that the dynamic behavior of the valve can be adapted individually to the particular situation of use. In this way, an economical solution is created for a highly dynamically operating valve having an electromagnetic drive.

In a development of the present invention, the first and second armature element can be connected in loose contact with one another, so that the armature elements can detach from one another. This achieves an optimization of the overall mass that is to be moved, made up of armature elements and valve needle, because only those armature elements have to be moved whose associated electromagnetic drives also exert a movement force on them. Thus, for example, a prespecified number of electromagnetic drives in the valve can be configured in series according to the present invention, but the dynamic characteristic of the valve can be set via a targeted controlling of individual electromagnetic drives.

Preferably, the second armature element can actuate the valve needle via the first armature element. In this way, in particular the number of parts can be kept very low.

The electromagnetic drives can also preferably be configured as a stack, so that the valve according to the present invention can be realized economically by simply layering the drives. In particular, the electromagnetic drives can be layered from the assembly side out, so that the individual electromagnetic drives can be tested for functional readiness ahead of time during production.

If the armature elements lie loosely against one another, the valve according to the present invention can also be maintained more easily, because defective electromagnetic drives can easily be removed from the stack and replaced by properly functioning new drives.

It is also preferred that the armature elements of the electromagnetic drives be identical in construction, so that the valve according to the present invention can be produced even more economically by simple stacking of elements having identical construction.

The electromagnetic drives can be situated in a common housing, such as a tube, so that the electromagnetic drives and the housing are provided in modular form, and the valve according to the present invention can be adapted to various applications and user needs not only during production but also afterwards. The valve according to the present invention can thus be assembled by the end user without difficulty and without special technical knowledge, both in large-scale technical production and in home work.

In an alternative or additional development of the present invention, the electromagnetic drives can be situated at a distance from one another, so that each armature element can execute an additional stroke when the preceding sliding armature element has reached its maximum stroke. In this way, through the spacing of the individual electromagnetic drives a partial stroke for the valve needle can be allocated to each individual electromagnetic drive in the valve according to the present invention, so that the valve needle executes a partial stroke when the armature element of the electromagnetic drive corresponding to the partial stroke has executed its full stroke. Thus, the advantages of highly dynamic switching magnets and of comparatively slow proportional magnets are united, which is a technological breakthrough, because a high dynamic characteristic in combination with variable strokes has up to now been reserved exclusively for valves having piezoelectric drives. In addition, the development of the invention is a simple solution, because the partial strokes of the valve, together with the configuration according to the present invention of the electromagnetic drives in series, can be realized using simple magnetic circuits and windings, without requiring a division of an individual magnetic circuit in the longitudinal direction. Preferably, the spacings between the electromagnetic drives are set using adjustment rings between the electromagnetic drives.

The spacings of the electromagnetic drives from one another can in particular become smaller as the distance from the valve needle becomes greater. In this way, the individual armature elements all lie against one another in the idle position of the valve needle, so that the high dynamic behavior according to the present invention of the valve is achieved for each individual partial stroke of the valve needle.

In a preferred development of the present invention, the valve has a control unit that can individually control each individual electromagnetic drive, and if warranted can even drive them directly. In this way, the valve can execute strokes of different sizes through individual controlling of electromagnetic drives.

This controlling can take place in such a way that the individual electromagnetic drives are driven individually, because here not only the dynamic characteristic of the switching process of the valve needle can be optimized, but also partial strokes of the valve needle can be set in stages of the individual strokes of the individual electromagnetic drives.

Alternatively, however, the control unit also offers the possibility of easily controlling all electromagnetic drives at the same time, and driving them in this way, which already results in an improved dynamic characteristic of the valve.

Here, the control unit can for example be provided for the step-by step activation or deactivation of the electromagnetic drives. Such a control schema is not only easy to realize electronically, but could also be realized mechanically.

The electromagnetic drives can preferably have an individual return element, such as an individual return spring, for resetting their armature element. In this way, the armature elements, which no longer have contact to the other armature elements and also are no longer driven, are moved back into their initial position, so that during the resetting of the valve needle less mass has to be moved by the general return element, so that a further improvement of the dynamic behavior is achieved.

The electromagnetic drive, which stands in direct contact with the valve needle, preferably has no return element of its own, because its armature element can be moved into its initial position individually by the general return element.

In a method according to the present invention for controlling a fluid passage using a valve needle having a first and second armature element, first the valve needle is moved by the second armature element via the first armature element. The valve needle is then moved back into its initial position by a return element.

Preferably, the valve needle can be further actuated or held by the first armature element at least after its actuation by the second armature element, so that only the mass of the first armature element and the mass of the valve needle still have to be driven in order to move the valve needle, thus achieving an optimization of the mass that is to be moved in a movement direction of the valve needle.

In particular, the second armature element can also be moved back into its initial position by the first armature element with holding or further actuation of the valve needle, so that during the movement of the valve needle in the other direction, it is still the case that only the first armature element and the valve needle have to be driven, thus achieving a further optimization of the mass to be moved.

If the first and second armature element contact one another in their initial positions—i.e., in the currentless state of the two electromagnetic drive elements—the valve needle can be actuated at least partially in common by the first and second armature element, so that during the driving of the valve needle a particularly large drive force is achieved that further improves the dynamic characteristic of the valve needle.

In a specific embodiment, the method according to the present invention can be realized with arbitrarily many armature elements. For example, an nth armature element, where n>2, can stand in contact in series with a preceding n−1th armature element, and can actuate the valve needle via all preceding n−1th armature elements connected in series, so that the dynamic improvement of the valve needle can be arbitrarily increased by arbitrarily many additional forces.

In particular, the valve needle can, at least after its actuation by the nth armature element, be further actuated or held by at least one of the n−1th armature elements. In this way, arbitrarily many partial strokes can be realized according to the present invention.

### BRIEF DESCRIPTION OF THE DRAWINGS

FIG. 1 shows a first specific embodiment of the valve according to the present invention.

FIG. 2 shows a second specific embodiment of the valve according to the present invention.

FIG. 3 shows a circuit diagram for a control unit for operating the second specific embodiment of the valve according to the present invention.

### DETAILED DESCRIPTION OF THE INVENTION

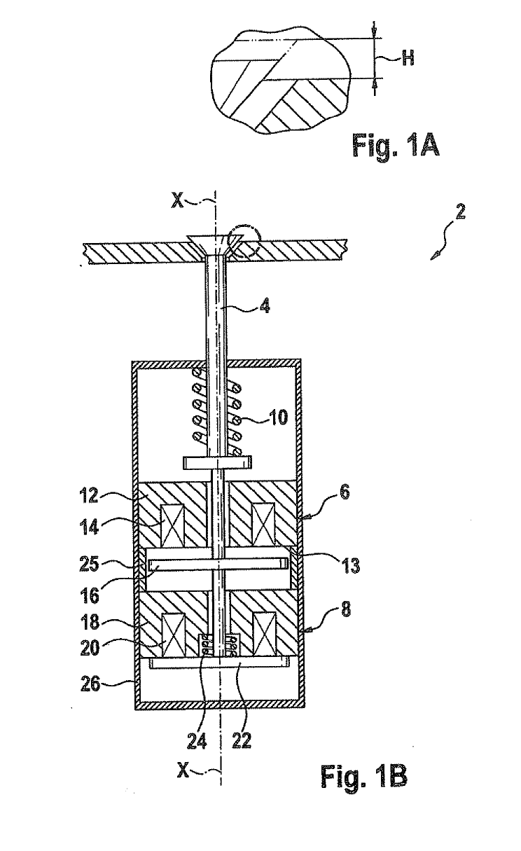

FIG. 1 shows a first specific embodiment of a valve 2 according to the present invention having a two-stage magnet stack. Such a valve 2 can be used for example as an injection valve in an internal combustion engine. Valve 2 has a valve needle 4, a first electromagnetic drive 6, and a second electromagnetic drive 8. While first electromagnetic drive 6 is provided for the direct actuation of valve needle 4, second electromagnetic drive 8 actuates the valve needle via first electromagnetic drive 6. First and second electromagnetic drive 6, 8 can together be moved back into a null position by a main return spring 10.

First electromagnetic drive 6 has a first magnetic circuit 12, a first winding 14, and a first armature element 16. First winding 14 can be supplied with current and then acts as a magnetic source voltage that flows through first magnetic circuit 12. First magnetic circuit 12 has pole shoes 13 from which the magnetic field can emanate from first magnetic circuit 12. First armature element 16 is magnetized, so that it can be attracted to pole shoes 13 by the magnetic field emanating from pole shoes 13 when first winding 14 is supplied with current.

Analogously to first electromagnetic drive 6, second electromagnetic drive 8 has a second magnetic circuit 18, a second winding 20, and a second armature element 22. These work together in the same way as their analogous elements in first electromagnetic drive 6. In addition, second electromagnetic drive 8 can have an individual return spring 24 with which second armature element 22 can be detached from first armature element 16 and individually moved back into its null position.

The two electromagnetic drives 6, 8 are stacked one over the other in a tube 26, and are separated from one another by a spacer element 25 in the form of an adjustment ring. First armature element 16 can move freely in the open space created in this way between first and second electromagnetic drive 6, 8. Through the stacking one over the other of additional spacer elements and electromagnetic drives, the configuration shown in FIG. 1 can be arbitrarily expanded depending on how many elements can still be fitted into the available space in tube 26. As shown in FIG. 1, armature elements 16, 22 and valve needle 4 are situated in series on a common axis X-X.

In the state of valve 2 shown in FIG. 1, the position of second armature element 22 in the attracted state can be seen, while first winding 14 of first armature element 16 is not supplied with current, so that valve needle 4 is held exclusively by second armature element 22 via first armature element 16. It can be seen clearly that in this way valve needle 4 has traveled only a part of its full possible stroke H. As a consequence, in order to further move valve needle 4 to its full stroke length H it is necessary merely to supply current to first winding 14.

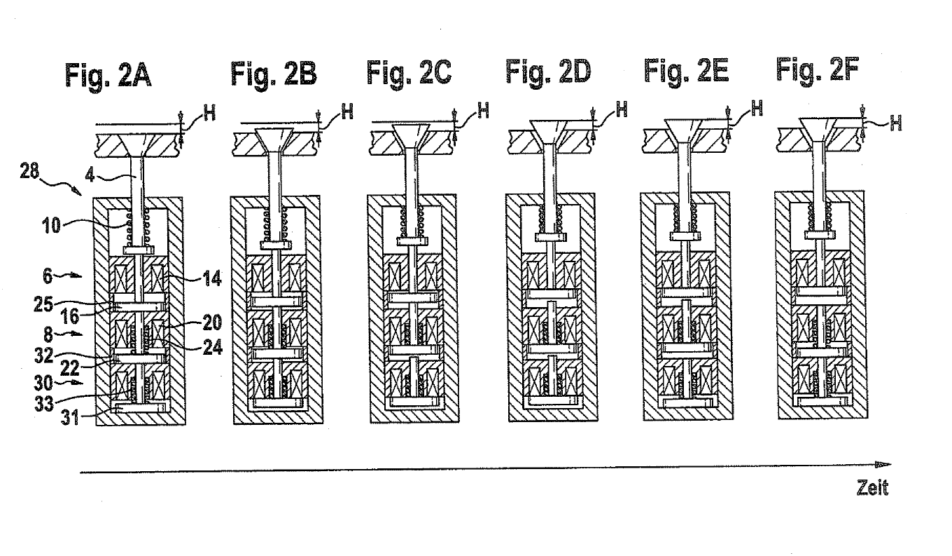

FIG. 2 shows a second exemplary embodiment of a second valve 28 according to the present invention having a three-stage magnet stack, in various functional states. For better clarity in FIG. 2, the individual elements of the magnet stack have not been provided with a reference character for each functional state.

On the basis of these functional states, the functioning of the present invention is now explained in more detail. The setting of a plurality of partial strokes is explained in more detail in the following.

Valve 28 shown in FIG. 2 has been expanded relative to valve 2 shown in FIG. 1 by a third electromagnetic drive 30 that is constructed in the same way as second electromagnetic drive 8. Third drive 30 is situated at a distance from second electromagnetic drive 8 via an additional spacer element 32, so that armature element 22 of second electromagnetic drive 8 can move freely. Spacer elements 25, 32 are selected such that the spacing between first and second electromagnetic drive 6, 8 is greater than the spacing between second and third electromagnetic drive 8, 30.

Valve needle 4 can execute a maximum stroke H that can be achieved by supplying current to at least winding 14 of first electromagnetic drive 6. The more windings in valve 28 that are additionally supplied with current, the faster valve needle 4 executes maximum stroke H.

Through a targeted supplying of current to the individual windings, valve needle 4 can also execute partial strokes between its null position (FIG. 2a) and maximum stroke H (FIG. 2d-2f). This is explained in more detail below on the basis of FIG. 2.

In the initial state a), valve needle 4 holds a fluid passage completely closed. All windings of electromagnetic drives 6, 8, 30 are without current, so that the spring force of main return spring 10 holds valve needle 4 and all armature elements in their null position. Here, the three armature elements 16, 22, 31 having identical construction are in loose contact with one another.

In state b), only the winding of third electromagnetic drive 30 is supplied with current, so that its armature element 31 reaches its end position, and, with a corresponding stroke, moves valve needle 4, via the other armature elements, into a position just past the null position. The attraction delay time is determined by armature element 31 of third electromagnetic drive 30. Because this drive has to produce only a partial stroke, the design can be compact and therefore highly dynamic. Windings 14, 20 of first and second electromagnetic drive 6, 8 can already be supplied with current at this time in order to build up a magnetic field and to continue the stroke movement of valve needle 4 without delay.

In state c), winding 20 of second electromagnetic drive 8 is additionally supplied with current, so that its armature element 22 reaches its end position and, with a corresponding stroke, moves valve needle 4, via armature element 16 of first electromagnetic drive 6, into a position just short of maximum stroke H. Because armature element 31 of third electromagnetic drive 30 has already reached its end position, it does not move further in the transition from state b) to state c), and remains in its stopped position. In this way, the moved mass is reduced.

Finally, in state d) current is supplied also to winding 14 of first electromagnetic drive 6, which now likewise reaches its end position and moves valve needle 4 into its end position with a corresponding stroke. Because the other armature elements 22, 31 have all already reached their end positions, for the transition from state c) to state d) it is further necessary merely to move armature element 16 of first electromagnetic drive 6, and valve needle 4. In this way, the moved mass is further reduced.

As soon as third electromagnetic drive 30 no longer makes any contribution to the opening force exerted on valve needle 4, the supply of current to its winding can be terminated. As shown in state e), its individual return spring 33 then moves its armature element 31 back into the null position.

In state f), current is supplied only to the winding of first electromagnetic drive 6, while armature elements 22, 31 of all other electromagnetic drives 8, 30 have again assumed their null position. Valve 28 is ready to be shut off. The preconditions for a highly dynamic switching process are optimal, because the release delay is determined only by the magnetic field buildup in first electromagnetic drive 6, which, due to its small stroke portion, can be optimized dynamically. Moreover, the moved mass is minimized.

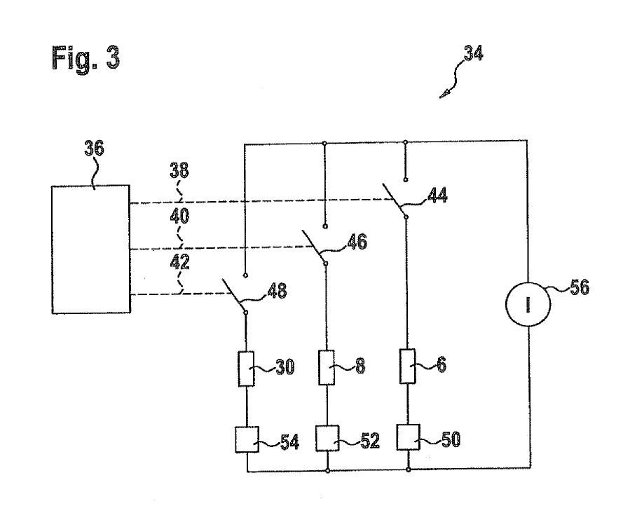

FIG. 3 shows a control unit for supplying current to the windings of electromagnetic drives 6, 8, 30 of the valve shown in FIG. 2. A signal unit 36 emits switching signals 38, 40, 42 that are provided for controlling switches 44, 46, 48. Each switch controls in this way the supply of current to one of the windings of electromagnetic drives 8, 6, 30, so that the valve needle can be moved according to FIG. 2. Pre-resistances 50, 52, 54 are provided in order to protect the windings. A voltage source 56 acts as an energy source. In this way, electromagnetic drives 6, 8, 30 are individually controllable so that valve 28 can execute partial strokes having different sizes, or can execute a full stroke.

1-15. (canceled)

16. A valve for controlling a fluid passage, comprising:
a valve needle;
a first electromagnetic drive having a first armature element for actuating the valve needle;
a return element for resetting the valve needle; and
a second electromagnetic drive having a second armature element for actuating the valve needle, wherein the first and second electromagnetic drives are configured in series.

17. The valve as recited in claim 16, the first and second armature elements are in loose contact with one another.

18. The valve as recited in claim 16, wherein the first and second armature elements are identical in construction.

19. The valve as recited in claim 16, wherein the first and second electromagnetic drives are arranged as a stack.

20. The valve as recited in claim 19, wherein the first and second electromagnetic drives are situated in a common housing.

21. The valve as recited in claim 19, wherein the first and second electromagnetic drives are situated at a distance from one another.

22. The valve as recited in claim 21, further comprising:
a third electromagnetic drive, wherein intervening spaces among the first, second and third electromagnetic drives become smaller as the distance from the valve needle becomes greater.

23. The valve as recited in claim 22, further comprising:
a control unit configured to individually control operation of each one of the first, second and third electromagnetic drives.

24. The valve as recited in claim 23, wherein the control unit is configured to provide one of (i) step-by-step activation of the first, second and third electromagnetic drives or (ii) step-by-step deactivation of the first, second and third electromagnetic drives.

25. The valve as recited in claim 22, further comprising:
a further return element associated with at least one of the second and third electromagnetic drives for resetting at least one of the second armature element of the second electromagnetic drive and a third armature element of the third electromagnetic drive.

26. A method for controlling a fluid passage through a valve having a valve needle, a first armature element, a second armature element, and a return element, wherein the valve needle and the first and second armature elements are configured in series, the method comprising:
actuating the valve needle by the second armature element via the first armature element, wherein the first armature element is situated between the valve needle and the second armature element; and
resetting the valve needle by the return element.

27. The method as recited in claim 26, wherein the valve needle is one of further actuated or held by the first armature element at least after actuation by the second armature element.

28. The method as recited in claim 27, wherein the second armature element is moved back into an initial position during one of the holding or further actuation of the valve needle by the first armature element.

29. The method as recited in claim 26, wherein in an initial position, the first and second armature elements contact one another, and wherein the valve needle is actuated at least partly in common by the first and second armature elements.

30. The method as recited in claim 26, wherein:
the valve further includes a third armature element which contacts in series with the second armature element;
the valve needle is actuated by the third armature element via the first and second armature elements connected in series; and
after the actuation of the valve needle by the third armature element, the valve needle is one of further actuated or held by at least one of the first and second armature elements.
